(19) United States
(12) Patent Application Publication
(10) Pub. No.: US 2003/0070076 A1
(43) Pub. Date: Apr. 10, 2003

(54) System and method for providing personal information about criminal offenders to a plurality of law enforcement agencies

(76) Inventor: Kenneth W. Michael, Duncanville, TX (US)

Correspondence Address: Michael L. Diaz, Michael L. Diaz, P.C., Suite 200, 555 Republic Drive, Plano, TX, 75074, US

(21) Appl. No.: 09/971,865

(22) Filed: Oct. 5, 2001

(51) Int. Cl. H04K 1/00

(52) U.S. Cl. 713/182

(57) ABSTRACT

A method and system for transferring data between a plurality of law enforcement agencies. The system includes at least a first input terminal of a first law enforcement agency, a second input terminal of a second law enforcement agency, and a computing system. The computing system stores any data sent from either the first or second input terminal in a database. When queried by either input terminal, the computing system searches the database, finds any requested information, and transfers the data to the requesting input terminal. The system may also include an authentication system for authenticating the proper users of the system.

### BACKGROUND OF THE INVENTION

1. Technical Field of the Invention

This invention relates to law enforcement databases and, more particularly, to a system and method for providing personal information about criminal offenders or suspects to a plurality of law enforcement agencies.

2. Description of Related Art

Computerized databases are well known in many industries. In particular, law enforcement agencies have each utilized computerized databases to track a myriad of data, from financial information for particular companies to personal information on individuals. However, although the use of computers and computerized databases have been introduced to law enforcement agencies, law enforcement agency computer systems suffer from significant disadvantages. None of the law enforcement agencies' computer systems effectively communicate or relay information from one law enforcement agency's database to another law enforcement agency's database.

At times, law enforcement agencies snare information with each other on a very limited and cumbersome basis. However, none of the different law enforcement agencies are connected to a network allowing for the transfer of criminal offender data to other law enforcement agencies. In fact, all law enforcement computer systems are isolated between individual agencies. Therefore, if information is required to be passed from one agency to another, a manual request asking for specific data must be made to identified law enforcement agencies.

It is common for a criminal offender committing crimes in a first geographic area of the country to commit crimes in another part of the country, without law enforcement agencies knowing of the offenses in the first geographic area. Thus, information which would be extremely helpful in criminal investigations is not automatically or systemically transferred between law enforcement agencies. A computer system and method is needed which enables one law enforcement agency to access information from another law enforcement agency allowing the simple transfer of data between the two agencies.

Although there are no known prior art teachings of a system or method such as that disclosed herein, prior art references that discuss subject matter that bears some relation to matters discussed herein are U.S. Pat. No. 5,510,978 to Colgan (Colgan), U.S. Pat. No. 5,912,947 to Langsenkamp et al.(Langsenkamp), U.S. Pat. No. 6,173,284 to Brown (Brown), and U.S. Pat. No. 6,188,939 to Morgan et al. (Morgan).

Colgan discloses a computerized police system for implementing an electronic data entry and processing system used by police officers. The system includes a variety of tools, enacted from a main menu screen that are utilized by the police. Each of the tools are logically grouped into documentation, investigation, resources and miscellaneous use. However, Colgan does not teach or suggest a network of law enforcement agencies which provide information between agencies. Colgan suffers from the disadvantage of utilizing only one law enforcement agency, without allowing the transfer of information with other law enforcement agencies.

Langsenkamp discloses a system having a first database having phone numbers and one or more data fields associated with each phone number. Phone numbers (callees) in the first database are selected based on the data fields associated with the callees. A recorded voice message is transmitted to the callees through a plurality of outgoing phone lines. The callees are prompted to enter one or several dial codes, which is then recorded. The database record of the callee is automatically updated based on the response dial code, so that the updated field may be used to select whether to send a future call to the callee. The system also includes a second database having records identifying convicted criminals. Each record in the second database includes one or more data fields associated with a convicted criminal. If the callee's dial code response indicates an interest in receiving information about convicted criminals, future calls are made to the callee concerning the existence of convicted criminals in a particular geographic area of interest. However, Langsenkamp does not teach or disclose a network which provides the transfer of information from one law enforcement agency to another law enforcement agency. Langsenkamp merely discloses a system for disclosing information on the release of specific criminals to certain callees. Langsenkamp also does not provide additional detailed information on the released criminals.

Brown discloses a system which provides for monitoring information or police reports in a police database to include newly entered reports for matches to predefined profiles. The predefined profiles are established by police officers and may include one or more request terms, a frequency term, and notification information of the officer who defined the profile. The frequency term defines how often the police database is searched for matches to the profile. The notification information is utilized to send notification to the police officer that defined the profile when a match occurs. However, Brown does not teach or suggest a system for transferring data from one law enforcement agency to another law enforcement agency. Brown merely determines when a number of specified events occur over a period of time.

Morgan discloses a centralized system that provides control of a plurality of subsystems associated with a police car or other emergency vehicles and which reduces the cockpit clutter associated with existing control systems. An emergency response system is utilized that rapidly coordinates and controls operation of a plurality of emergency subsystems associated with a predetermined scheme of operation of the devices. The controller receives a single input command and, in response, provides specific device control commands to several individually controlled devices. Morgan does not teach or suggest a system which provides for the transfer of detailed data on criminal detainees. Morgan merely discloses a control system for use by law enforcement agencies, without any transfer of detailed criminal data. Review of the foregoing references reveals no disclosure or suggestion of system or method which provides the transfer of detailed data on criminal offenders to a plurality of law enforcement agencies. It is an object of the present invention to provide such a system and method.

### SUMMARY OF THE INVENTION

In one aspect, the present invention is a system for transferring data between different entities. The system includes a computing system, a first input terminal for communicating between a first operator of a first entity, and a second input terminal for communicating between a second operator of a second entity. The computing system accepts data from the first and second input terminals in a standardized format allowing the transfer of data between the first and second entities.

In another embodiment of the present invention, the system is a system for transferring data between different law enforcement agencies. The system includes a computing system, a first input terminal for communicating between a first operator of a first law enforcement agency and the computing system. The first input terminal has a first bio-scan device for authenticating the first operator. The system also includes a second input terminal for communicating between a second operator of a second law enforcement agency and the computing system. The second input terminal has a second bio-scan device for authenticating the second operator. The computing system accepts data from the first and second input terminals in a standardized format, allowing the transfer of data between the first and second entities.

In still another aspect, the present invention is a method of transferring data between a first entity and a second entity through a computing system. The method begins by a first user of a first input terminal of the first entity providing data to the computing system. Next, the computer system receives any data inputted by the first input terminal in a standardized format readable by the computing system. The computing system then stores any data inputted by the first input terminal. Next, the computing system transfers any stored data to a second input terminal of a second entity.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system 20 for providing data on criminal offenders/suspects in the preferred embodiment of the present invention;

FIG. 2 is a table illustrating an exemplary list of logging activity data of all users and client computers;

FIG. 3 is a table illustrating an exemplary listing of all subscribing law enforcement agencies utilizing the system;

FIG. 4 is a table illustrating data for all subscriber terminals within the system;

FIG. 5 is a table illustrating data for all associations or gang related data;

FIG. 6 is a table illustrating data associated with a bio-scan system used in authentication of users of the system;

FIG. 7 is a table illustration data relating to bookings of all criminal offenders or suspects;

FIG. 8 is a table illustrating data for word processor documents or other word processing files associated with criminal offenders or suspects;

FIG. 9 is a table illustrating data on any error messages associated with log activity with the system;

FIG. 10 is a table illustrating data for images and locations of distinguishing marks such as tattoos, scars, and birthmarks;

FIG. 11 is a table illustrating data for any comments by investigators or law enforcement officials related with criminal offenders or suspects;

FIG. 12 is a table illustrating data on any individual being tracked by the system to include criminal offenders, suspects, or known acquaintances;

FIG. 13 is a table illustrating data on criminal offences and suspects as they are associated with gangs or associations;

FIG. 14 is a table illustrating any data relating to images of the criminal offenders or suspects;

FIG. 15 is a table illustrating data of various categories of activities supported by the system;

FIG. 16 is a table illustrating data collected on individuals utilizing the system;

FIG. 17 is a table illustrating data associated with users of the system 20 and input terminals;

FIG. 18 is a table storing data that relates users of the system with any category of activities supported by the system;

FIG. 19 is a table illustrating data correlating alias names associated with criminal offenders;

FIG. 20 is a simplified block diagram illustrating the communication linking components of the system in the preferred embodiment of the present invention; and

FIGS. 21A and 21B are flow charts outlining the steps for providing information on criminal offenders to a plurality of different law enforcement agencies according to the teachings of the present invention.

### DETAILED DESCRIPTION OF EMBODIMENTS

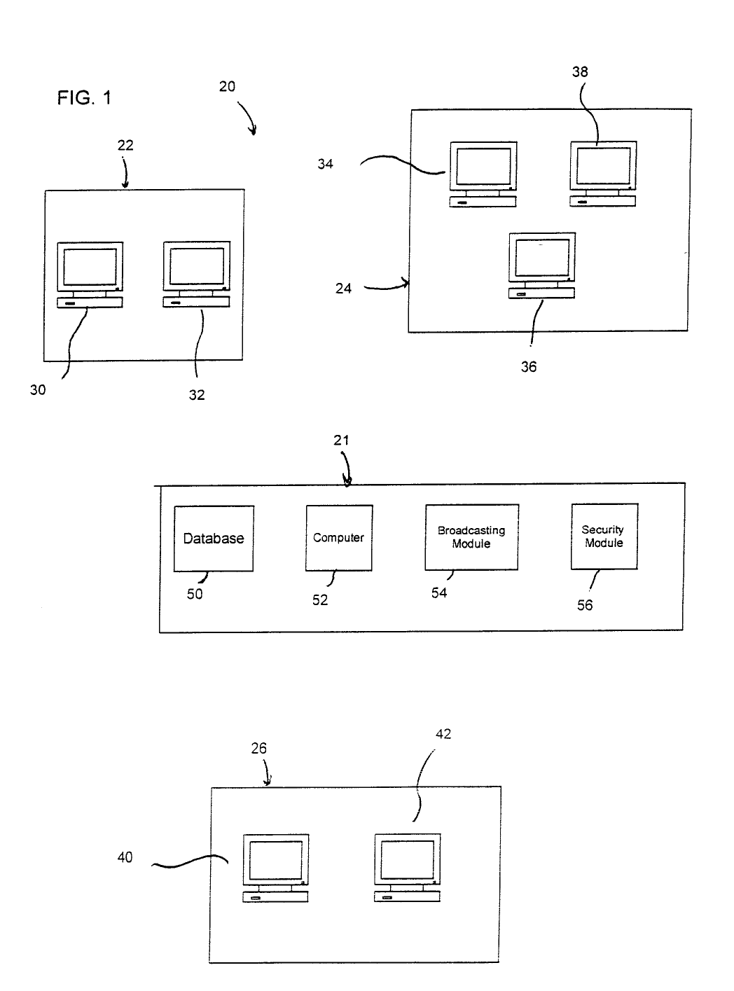

The present invention is a system and method for providing detailed data on-a criminal offender/suspect to a plurality of law enforcement agencies. FIG. 1 is a simplified block diagram illustrating the components of a system 20 for providing data on criminal offenders/suspects in the preferred embodiment of the present invention. The system includes a computing system 21 in communication with a plurality of law enforcement agencies 22, 24, and 26. Each law enforcement agency may be a separate or associative entity with other law enforcement agencies. For example, law enforcement agency 22 may be the City of Dallas Police Department, law enforcement agency 24 may be the City of Chicago Police Department, and law enforcement agency 26 may be the Federal Bureau of Investigation (FBI). The system may incorporate any type and level of law enforcement agency. Three law enforcement agencies are illustrated for simplicity, however, it should be understood that any number of law enforcement agencies may be utilized in the system 20.

Within each law enforcement agency may be a plurality of input terminals. For example, in law enforcement agency 22, two input terminals 30 and 32 are located. The physical location of the input terminals may vary. The input terminal area of operation and location are dependent upon the jurisdiction and authority. Law enforcement agency 24 may include input terminals 34, 36, and 38. Law enforcement agency 26 may include input terminals 40 and 42. Again, any number of input terminals may be employed.

Each input terminal (30, 32, 34, 36, 38, 40 and 42) may be any device which allows a terminal operator to provide data or receive data from the computing system 21. The input terminals may each include a conventional or propriety setup of a computer terminal and may include a keyboard, a touch screen, or voice recognition system. In an alternate embodiment of the present invention, each input terminal may be a conventional wireless personal data assistant (PDA). Each input terminal may be wired directly to the computing system 21 or communicate via wireless communications, which is well known in radio telecommunications systems. It must be understood, that any device may be used which can effectively transfer data between the input terminal and the computer system 21. Additionally, the inputted data may be encrypted for secure transmission to the computer. The input terminals may include terminal encryption modules (not shown) to encrypt data prior to transmission to the computing system. In the preferred embodiment of the present invention, each input terminal may also communicate with the computing system via the Internet.

In an alternate embodiment of the present invention, each law enforcement agency may include its own local area network (LAN) which communicates with the computing system 21. The input terminal may communicate through the LAN to the computing system 21. Although computer terminals and mobile communication devices are discussed, any communication device which allows the transfer of information between the input terminals or law enforcement agencies and the computing system may be utilized.

The computing system 21 also includes a database 50 for storing data received from the plurality of law enforcement agencies and their associated input terminals. In addition, the computing system may also include a computer 52 providing searching functions for the law enforcement agencies of the database. In addition, the computer 52 receives all data received from the law enforcement agencies and arranges the data into a standardized format, allowing simple and effective retrieval of all data stored within the database. The standardized format is employed through a formatted input screen. The computing system may also include a broadcasting module 54 which broadcasts data on a criminal offender to selected law enforcement agencies.

The computing system 21 may be any conventional computer having the necessary computing power to store data within one or more databases and provide calculations and correlations based on the stored and inputted data.

The database 50 may store a plurality of data packets for dissemination to the various law enforcement agencies. In the preferred embodiment of the present invention, the database is used for the storage of any relevant information on criminal offenders, suspects, criminal patterns, queries, and activity logs. For example, textual data, images such as photographs and fingerprints, and any other imagery may be stored within the database 50.

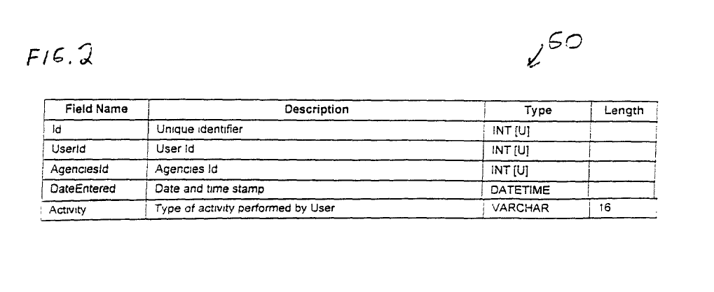

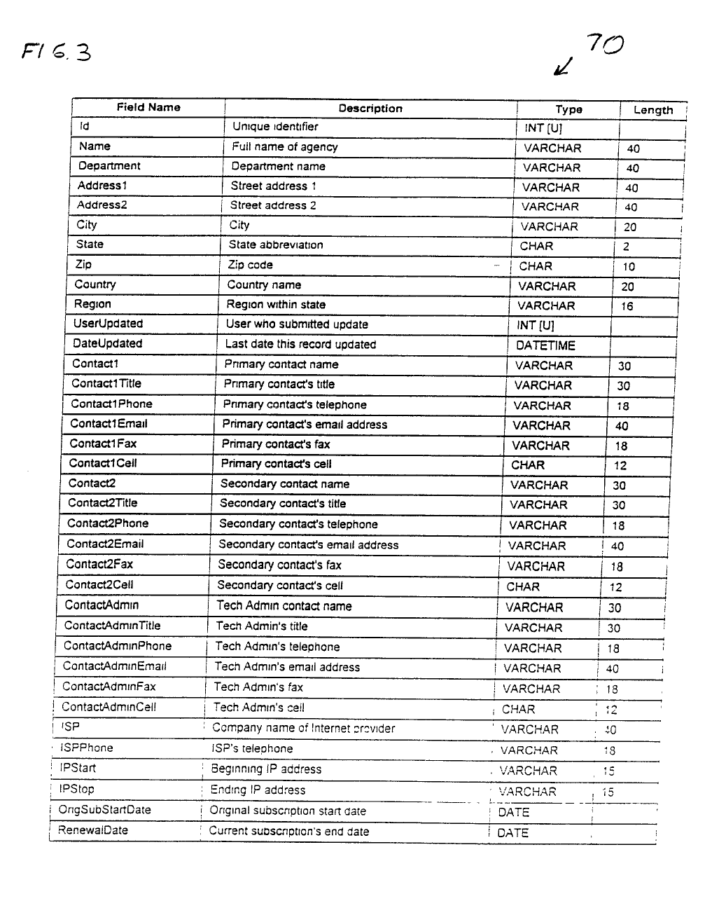

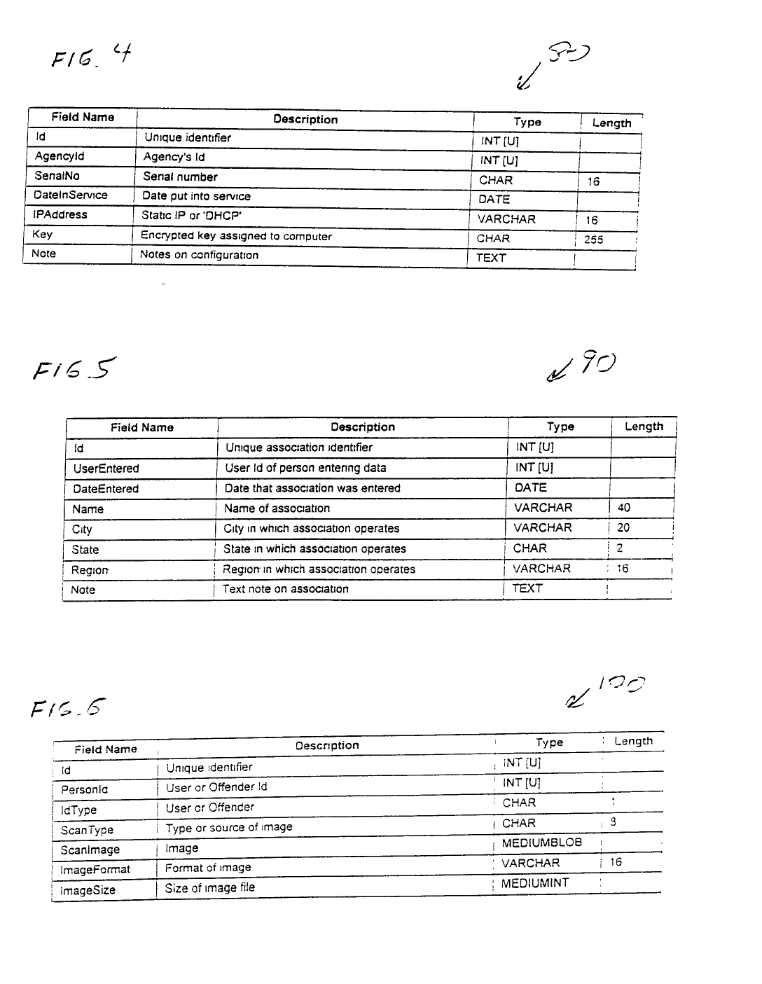

FIG. 2 is a table 60 illustrating an exemplary list of logging activity data of all users and client computers. FIG. 3 is a table 70 illustrating an exemplary listing of all subscribing law enforcement agencies utilizing the system 20. FIG. 4 is a table 80 illustrating data for all subscriber terminals within the system 20. FIG. 5 is a table 90 illustrating data for all associations or gang related data. FIG. 6 is a table 100 illustrating data associated with a bio-scan system used in authentication of users of the system 20. The bio-scan system will be discussed below.

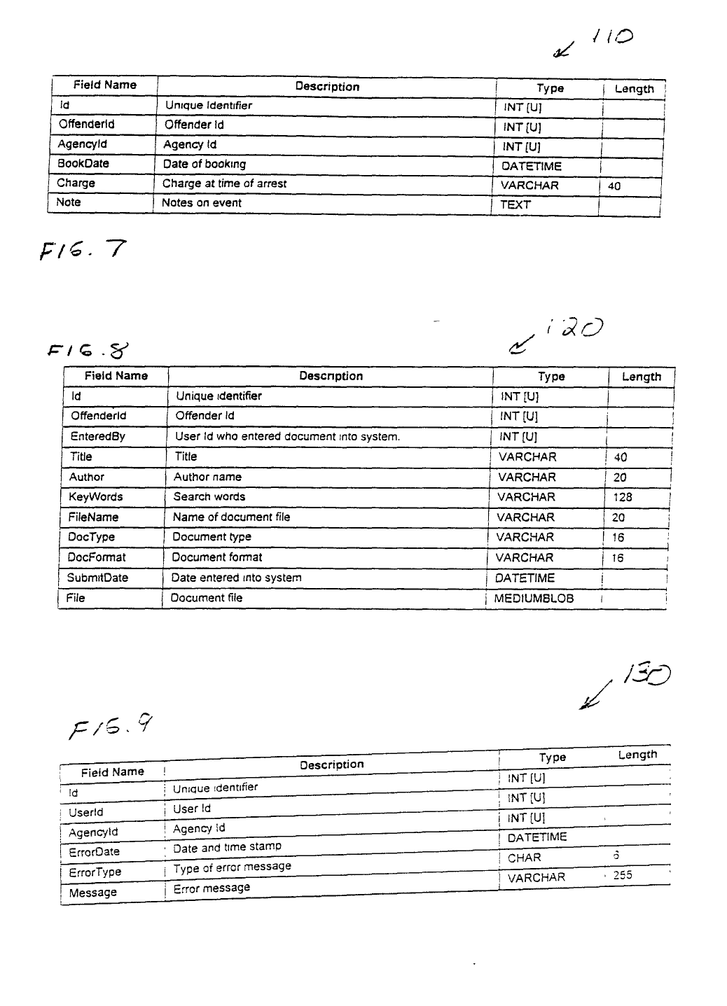

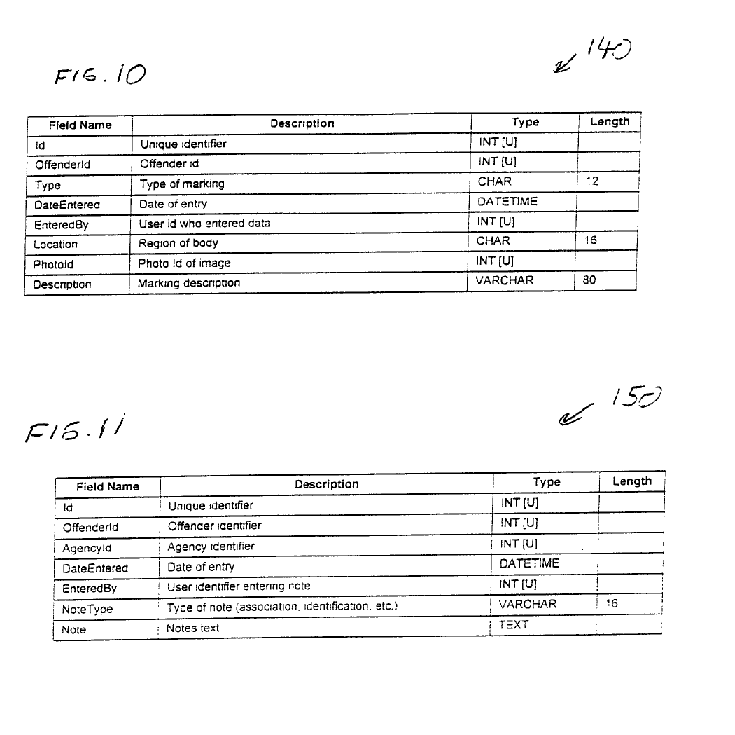

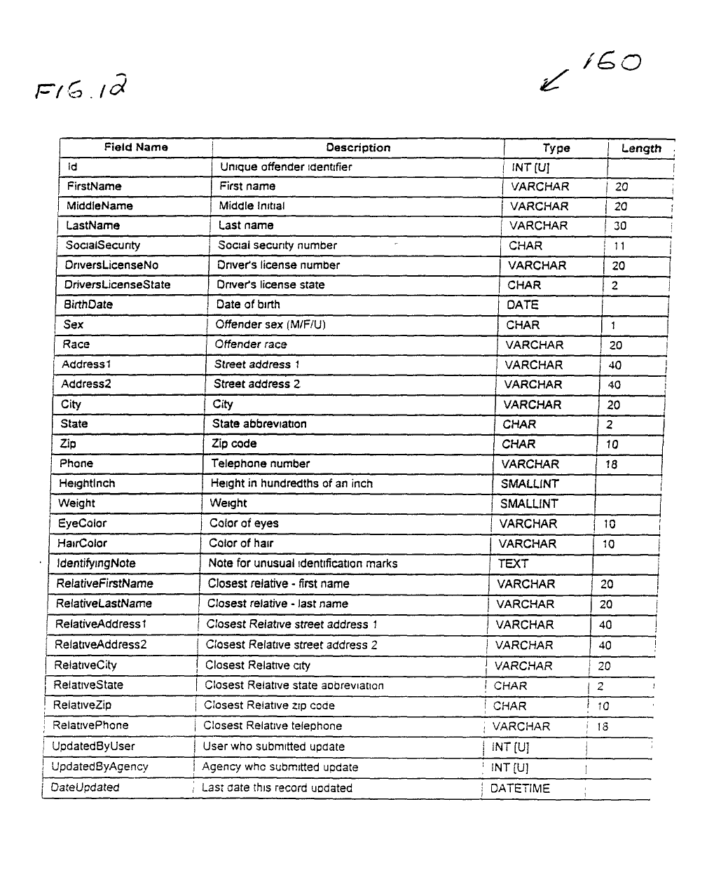

FIG. 7 is a table 110 illustration data relating to bookings of all criminal offenders or suspects. FIG. 8 is a table 120 illustrating data for word processor documents or other word processing files associated with criminal offenders or suspects. FIG. 9 is a table 130 illustrating data on any error messages associated with log activity with the system 20. The table 130 may be used to analyze any faults or determine the operational status of the system 20 or its associated law enforcement agencies. FIG. 10 is a table 140 illustrating data for images and locations of distinguishing marks such as tattoos, scars, and birthmarks. In addition, FIG. 11 is a table 150 illustrating data for any comments by investigators or law enforcement officials related with criminal offenders or suspects.

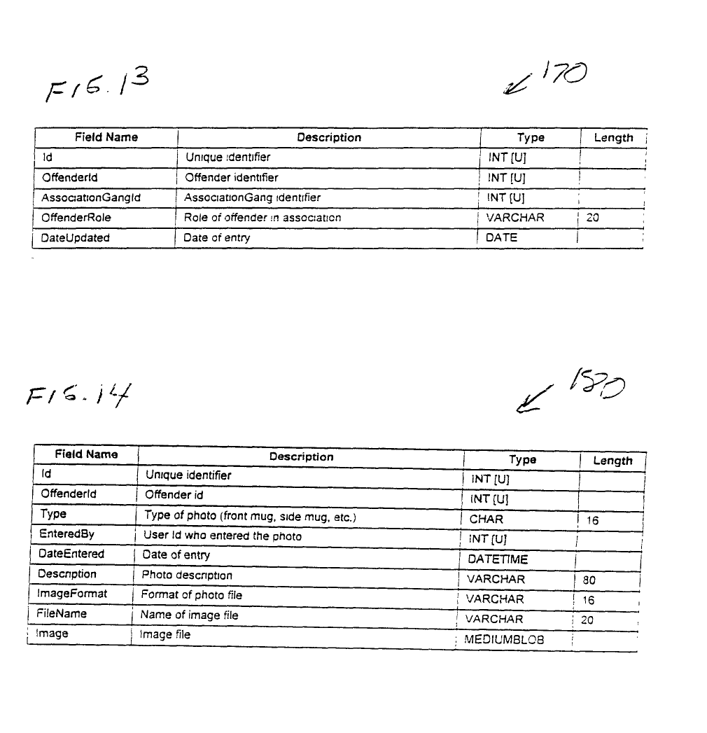

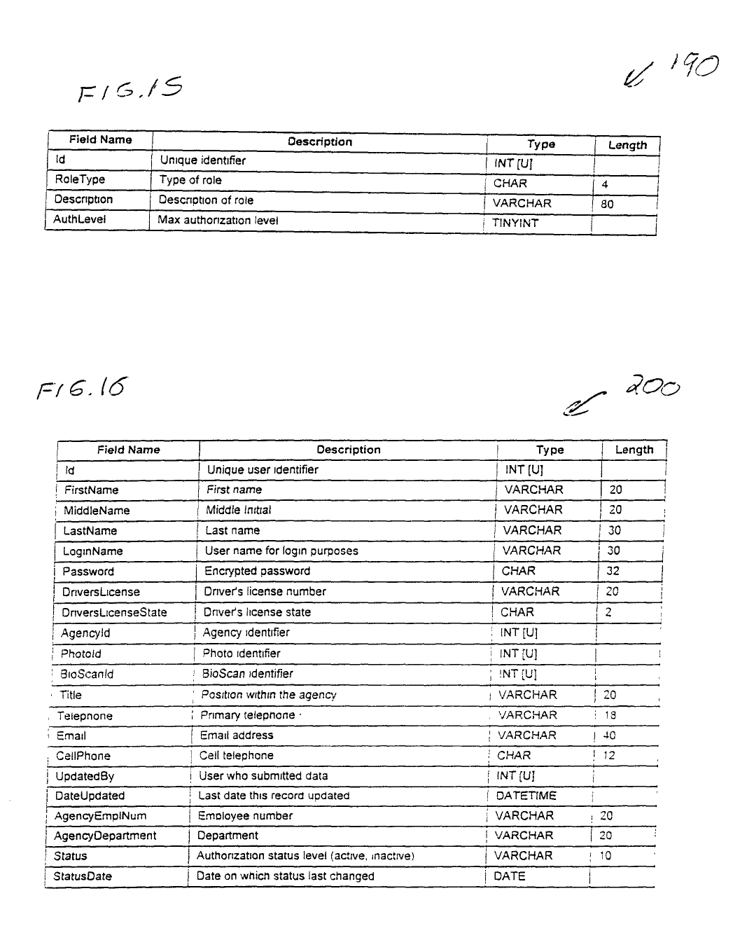

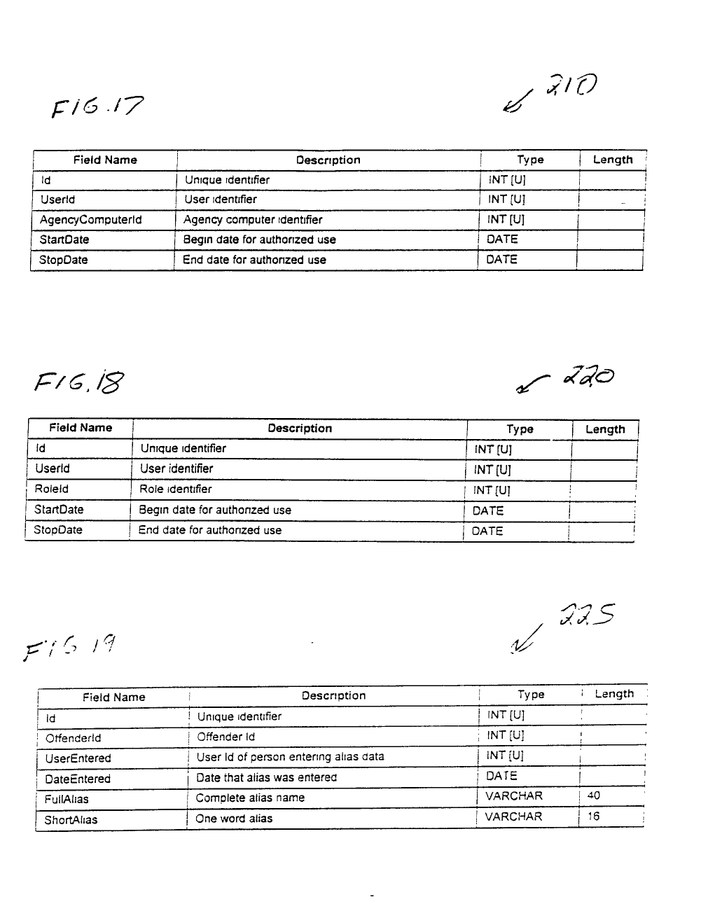

FIG. 12 is a table 160 illustrating data on any individual being tracked by the system 20 to include criminal offenders, suspects, or known acquaintances. FIG. 13 is a table 170 illustrating data on criminal offences and suspects as they are associated with gang or associations. FIG. 14 is a table 180 illustrating any data relating to images of the criminal offenders or suspects. The data may include photographs, X-rays, or any other visually based data. FIG. 15 is a table 190 illustrating data of various categories of activities supported by the system 20. FIG. 16 is a table 200 illustrating data collected on individuals utilizing the system 20.

FIG. 17 is a table 210 illustrating data associated with users of the system 20 and input terminals. The table may be used to tie users to specific input terminals. FIG. 18 is a table 220 storing data that relates users of the system 20 with any category of activities supported by the system. FIG. 19 is a table 225 illustrating data correlating alias names associated with criminal offenders.

Each table illustrated above may be designed to fall within a standardized format allowing the assimilation of a plurality of data packets from different law enforcement agencies into one database. The database 50 may provide a plurality of data packets to subscribers of the system 20, as illustrated in FIG. 1, law enforcement agencies 22, 24, and 26. As illustrated, the tables above show four categories: field name, description, data type, and data length. However, the format and categories of the data packets may be different, depending on the type and quantity of law enforcement agencies subscribing to the system 20.

The computing system 21 may categorize all data, including images, into specific Meta Data designator fields, such as author, title and version and store the data within the database 50. By utilizing Meta Data designator fields, an operator of the system 20 may search for individuals based on the Meta Data fields associated with each type of data. Operators subscribing to the system 20 may query all data contained within the database 50. Thus, all data from all the subscribing law enforcement agencies is available to all subscribers. In alternate embodiments of the present invention, the system 20 may use any format which allows the transfer of information between law enforcement agencies.

In the preferred embodiment of the present invention, the system 20 utilizes a security module 56 to prevent unauthorized use of the system 20. In order to be an authorized user, the user must be a subscriber to the system 20. In the preferred embodiment of the present invention, all authorized nodes connected within a localized network of the subscribing law enforcement agency may communicate with the computing system 21. However, in alternate embodiments, a single or multiple users/entities may communicate directly to the computing system 21. For a law enforcement agency to become an authorized user, it must subscribe to the service provided by the system 20.

In addition, to provide greater security to the system 20, a separate input terminal dedicated to use with the system 20 is employed. The input terminals are preferably customized personal computers (PCs). The input terminals may incorporate unique hardware for facilitating the transfer of data between the subscribing law enforcement agencies and the computing system 21. For example, the customized input terminals may include cameras and scanners for the transfer of images such as photographs of individuals and fingerprints. The input terminal may also include encrypted messaging between clients and servers (input terminals and computing system 21). In the preferred embodiment of the present invention, each input terminal includes a biological security device 58 capable of scanning fingerprints of the terminal user or a retina scan of the user's eyes.

To increase security with the system 20, a firewall is preferably employed to protect the terminal from unauthorized access to the data on the input terminal. This firewall may be through separate hardware or software. A soft key may also be incorporated to provide a means of identifying each input terminal and encrypting messages sent directly to the computing system 21. An encrypted or virtual private network purely dedicated to the system 21 may also be employed. Again, this security network may be employed through the use of separate hardware or software. It must be understood, that any security measure which prevents the unauthorized access to data of the computing system 21 or its affiliate input terminals may be utilized.

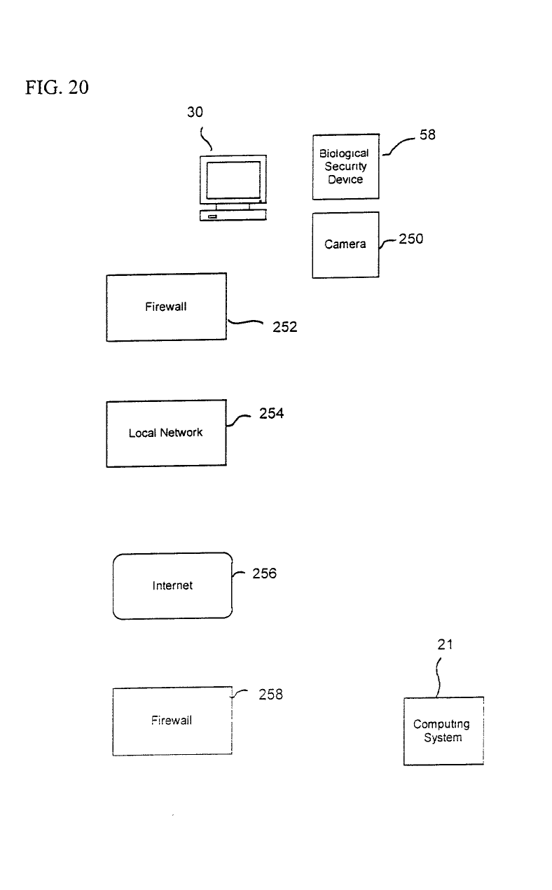

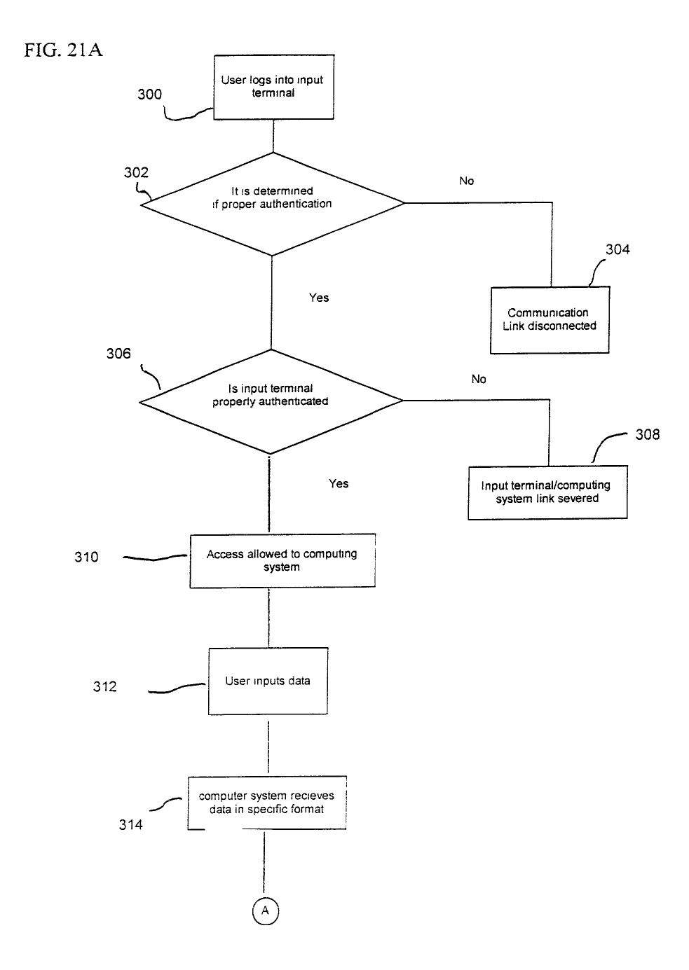

FIG. 20 is a simplified block diagram illustrating the communication linking components of the system 20 in the preferred embodiment of the present invention. The input terminal 30 may include a camera 250 and a biological security device 58. A firewall 252 may also be employed as either hardware or software within the input terminal. The input terminal may optionally communicate through a local network (client) 254 to facilitate communication through the Internet 256. The computing system 21 may communicate with the input terminal 30 through a firewall 258 for added security.

The system 20 preferably utilizes a web-based interface, such as HTML (e.g., text, images, data input forms and https/CGI protocol), Java applets (e.g., activities where the interface becomes complex and present a large amount of text data and images), Java droplets, Java applications, and C++ image capture (for storage of image data in a temporary file on disc). However, any interface may be utilized which provides for the transfer of any type of data to remote locations.

Although the system 20 is geared primarily for law enforcement agencies and the transfer of data relating to criminal offenders, suspects or persons incarcerated by the law enforcement agencies, alternate embodiments may also utilize the basic components and concept of the present invention. For example, the system 20 may be applied by private business entities for background checks of employees, customers, or affiliated business entities and their employees.

Additionally, the system 20 may be employed by other governmental entities which require the transfer of data on specific individuals to different agencies. For example, currently the United States Immigration and Naturalization Service (INS) tracks data on a plurality of individuals, specifically those individuals residing in this country who are not citizens of the United States. However, information from the United States Department of State, the Internal Revenue Service, and the Federal Bureau of Investigation does not have a common dedicated system for transferring information on individuals from one agency to another agency. The system 20 may be employed to allow the separate agencies to share information.

With increased interest in airport security, the system 20 may be effectively utilized to prevent criminal offenders or suspects from entering security airport zones. Specific individuals for which law enforcement entities are watching or suspect of any criminal activity may be effectively communicated to airport security officials having an input terminal communicating with the computing system 21.

In addition, through the use of the broadcasting module 54, specific law enforcement agencies may broadcast data which may be relevant to single or a plurality of law enforcement agencies. For example, if a suspect is wanted by a particular law enforcement agency, the law enforcement agency may broadcast a bulletin requesting the confinement of the individual, or any relevant data on the specified individual.

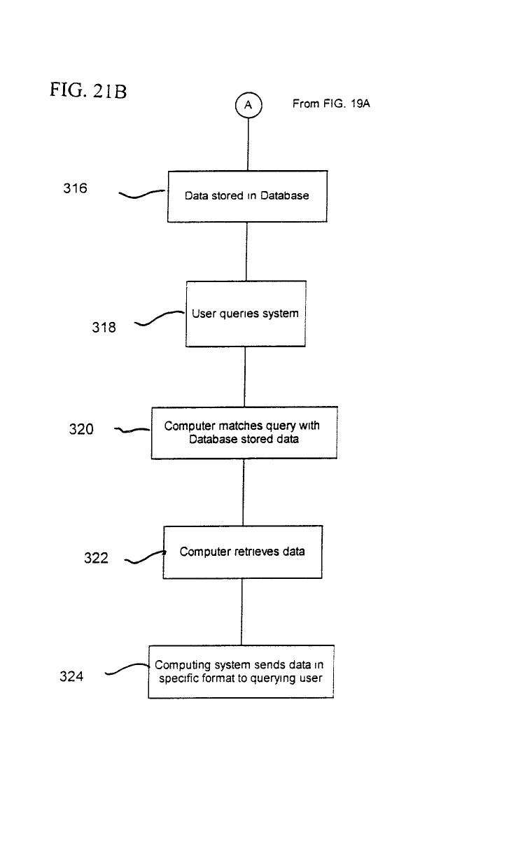

FIGS. 21A and 21B are flow charts outlining the steps for providing information on criminal offenders to a plurality of different law enforcement agencies according to the teachings of the present invention. With reference to FIGS. 1 and 19, 21A and 21B, the steps of the method will now be explained. The method begins with step 300, where a user of the system 20 logs into the system 20 via the input terminal 30. In order to utilize the system 20, the operator must be an authorized operator of the system 20 and a member of the law enforcement agency 22. Therefore, in step 302, it is determined if the user is authenticated to ensure that the user is properly authorized to use the system 20. The authentication of the user may be accomplished by a simple password/user name verification. The user may also be authenticated by a biological scan from the biological security device 58 located within or in close proximity to the input terminal. The biological security device may include a fingerprint or retina scan system to determine if the user is properly identified. If the user is not authenticated, the method moves to step 304, where the system 20 disconnects the communications link with the input terminal. In addition, the computing system 21 (through the broadcasting module 54), may optionally broadcast a warning to other entities either within or outside the law enforcement agency 22.

However, if the user is properly authenticated, the method moves from step 302 to step 306 where it may be determined if the input terminal from which the user is accessing the system 20 is authorized access to the computing system 21. The input terminal may be authenticated as the proper input terminal having authorized access to the computing system 21 in a various ways. For example, the computing system 21's IP address may be verified through a lookup table stored within the database 50. If the computing system 21 determines that the input computer is denied access, the system moves to step 308, where the communications link between the input terminal and the computing system is severed. In addition, the computing system 21 (via the broadcast module) may broadcast a warning of any attempted unauthorized use to other operators or law enforcement agencies. This access warning may be used by law enforcement agency members to act in apprehending any criminal offender attempting to breach the security of the system 20.

However, if it is determined that the input terminal 30 is properly accessing the computing system 21, the method may move from step 306 to 310 where the input terminal is allowed access to the computing system 21, the database 50, and the broadcasting module 54. The user may provide information to the computing system 21 through the input terminal. Thus, the method may optionally move to step 312 where the user inputs data regarding one or more criminal offenders into the input terminal 30.

Next, in step 314, the computing system 21 receives the data from the user in a standardized format. In step 316, the computing system 21 stores the data within the database 50. Next, in step 318, an authorized user (e.g., originating from law enforcement agency 22) of the system 21 may optionally direct a query to the computing system. The authorized user is logged into the system 20 allowing communication with the computing system 21. In step 320, the computer 52 matches the query by searching the database for the requested information. In step 322, the computer 52 retrieves any requested data. In step 324, the computing system sends the data in the specified format to the querying user.

Although the system 20 is geared primarily for law enforcement agencies and the transfer of data relating to criminal offenders or persons held by law enforcement agencies, the method discussed in FIGS. 21A and 21B may be utilized by any plurality of organizations requiring the exchange of information. For example, private companies may exchange information as described above. The private companies may use the system 20 to perform background investigations of its perspective or present employees. The method may also be used in airport security by establishing an exchange of information between airport security forces and other law enforcement agencies. In addition, the method may be used by separate governmental agencies to allow one agency (e.g., the INS) to transfer information with another entity (e.g., department of state).

The system 20 provides many advantages over existing databases. The system 20 and its associated method allow separate law enforcement agencies to freely exchange information between each other. By providing a unique standardized formatting system, the exchange of data to the computing system 21 and various law enforcement agencies may be accomplished. In addition, the system 20 permits only authorized operators to access sensitive and personal data about individuals, thus safeguarding data which should not be released to the general public. The system 20, in the preferred embodiment of the present invention, utilizes a biological security device to verify the identity of the individual logging into the system 20. The biological security device may use a scan of a fingerprint or the person's retina to determine the identity of the person. In addition, digitized images may also be transferred easily to the computer system 21. The system 20 may also utilize the Internet to allow a communications link between the computing system 21 and the plurality of law enforcement agencies.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for transferring data between different entities, said system comprising:
a computing system;
a first input terminal for communicating between a first operator of a first entity and the computing system;
a second input terminal for communicating between a second operator of a second entity and the computing system;
whereby the computing system accepts data from the first and second input terminals in a standardized format allowing the transfer of data between the first and second entities.

2. The system for transferring data of claim 1 wherein the first and second entities are law enforcement agencies.

3. The system for transferring data of claim 1 wherein the computing system includes a centralized database for storing data received from a plurality of input terminals.

4. The system for transferring data of claim 1 wherein the computing system receives queries from at least one input terminal and answers the query by accessing the database for requested data.

5. The system for transferring data of claim 1 wherein the first input terminal includes means for authenticating the proper access to the computing system.

6. The system for transferring data of claim 1 wherein the means for authenticating the proper access includes a bio-scan device to authenticate an identity of the operator of the first input terminal.

7. The system for transferring data of claim 1 wherein the first input terminal communicates data to the computing system in a specified format standardized to allow communication with the second input terminal.

8. The system for transferring data of claim 1 wherein the computing system communicates data to the first input terminal in a specified format standardized to allow communication with the second input terminal.

9. The system for transferring data of claim 1 wherein the computing system includes means for broadcasting data to a plurality of entities when a specified event occurs.

10. The system for transferring data of claim 1 wherein the computing system includes means to determined that the first input terminal is authorized to communicate with the computing system.

11. The system for transferring data of claim 1 wherein the computing system includes means to determine that the first operator is authorized to access data from the computing system.

12. The system for transferring data of claim 1 wherein the computing system includes means for answering a query from the first input terminal, the computing system matching the query with data stored in a database of the computing system.

13. The system for transferring data of claim 1 wherein the computing system includes means for transferring images from the first input terminal to the second input terminal.

14. A system for transferring data between different law enforcement agencies, said system comprising:
a computing system;
a first input terminal for communicating between a first operator of a first law enforcement agency and the computing system, the first input terminal having a first bio-scan device for authenticating the first operator; and
a second input terminal for communicating between a second operator of a second law enforcement agency and the computing system, the second input terminal having a second bio-scan device for authenticating the second operator;
whereby the computing system accepts data from the first and second input terminals in a standardized format allowing the transfer of data between the first and second entities.

15. A method of transferring data between a first entity and a second entity through a computing system, said method comprising the steps of:
providing, by a first user of a first input terminal of the first entity, data to the computing system;
receiving, by the computing system, any data inputted by the first input terminal in a standardized format readable by the computing system;
storing, by the computing system, any data inputted by the first input terminal;
transferring, by the computing system, any stored data to a second input terminal of a second entity.

16. The method of transferring data of claim 15 wherein the first and second entities are law enforcement agencies.

17. The method of transferring data of claim 15, further comprising, before the step of providing data to the computing system, the step of authenticating the first user to determine if the first user has proper access to the computing system.

18. The method of transferring data of claim 15, further comprising, before the step of providing data to the computing system, the step of authenticating the first input terminal to determine if the first input terminal may access the computing system.

19. The method of transferring data of claim 15, further comprising, after the step of providing, by a first user of a first input terminal of the first entity, data to the computing system, the steps of:
providing, by the first user, a trigger event to broadcast the data provided to the computing system;
determining, by the computing system, when the trigger event occurs;
broadcasting by the computing system the data to the second input terminal when the trigger event occurs.
